(19) United States
(12) Patent Application Publication
(10) Pub. No.: US 2010/0171822 A1
(43) Pub. Date: Jul. 8, 2010

(54) Tomographic image capturing apparatus and tomographic image capturing method

(75) Inventors: Hirofumi Sawada, Minami-ashigara-shi (JP); Jun Enomoto, Kanagawa-ken (JP); Sadato Akahori, Odawara-shi (JP); Eiichi Kanagawa, Minami-ashigara-shi (JP); Tomoyoshi Nishimura, Tokyo (JP); Yasunori Ohta, Yokohama-shi (JP); Noriaki Ida, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/654,814

(22) Filed: Jan. 5, 2010

(30) Foreign Application Priority Data
Jan. 6, 2009 (JP) 2009-000950

(51) Int. Cl. G06T 7/00; H05G 1/60; H04N 7/18

(52) U.S. Cl. 348/77; 378/27; 382/131; 348/E07.085

(57) ABSTRACT

A tomographic image capturing apparatus comprises a radiation source for applying radiation to a subject at a plurality of different angles with respect to the subject, a radiation detector for detecting the radiation which has passed through the subject at each of the different angles and converting the detected radiation into image data, a tomographic image reconstructing unit for processing the image data into a reconstructed tomographic image, and an image capturing continuation determining unit for determining whether image-capturing of the subject is continued or not based on the reconstructed tomographic image.

### CROSS-REFERENCE TO RELATED APPLICATION

This application is based upon and claims the benefit of priority from Patent Application No. 2009-000950 filed on Jan. 6, 2009, in the Japan Patent Office, of which the contents are incorporated herein by reference.

### BACKGROUND OF THE INVENTION

1. Field of the Invention

The present invention relates to a tomographic image capturing apparatus and a tomographic image capturing method for generating a tomographic image (reconstructed tomographic image) at a desired sectional position in a subject by reconstructing tomographic image data from a plurality of image data.

2. Description of the Related Art

Heretofore, tomosynthesis has been widely used for generating a tomographic image (reconstructed tomographic image) at a desired sectional position (slice height) in a subject by irradiating the subject with radiation beams emitted from a radiation source disposed at different angles, detecting the radiation beams that have passed through the subject with a radiation detector and converting the detected radiation beams into radiographic image information (image data), and reconstructing tomographic image data from the image data (see Japanese Laid-Open Patent Publications No. 2004-130105 and No. 2004-130133).

Japanese Laid-Open Patent Publications No. 2004-130105 and 2004-130133 disclose a tomographic image capturing apparatus for acquiring a desired reconstructed tomographic image by moving the radiation source relative to the subject in one direction.

In the above tomographic image capturing apparatus, radiation is applied to the subject (e.g., patient) at a plurality of different angles to acquire a plurality of image data, and thereafter the acquired image data are processed to generate a reconstructed tomographic image. Thus, it takes a long period of time to capture a tomographic image. During such a long period time, it is difficult for the subject to keep still. If the subject accidentally moves during the image-capturing, an inappropriate reconstructed tomographic image (that is not suitable for image diagnosis by a doctor) is produced.

After the reconstructed tomographic image has been generated, the doctor finally judges whether the reconstructed tomographic image is acceptable or not. Thus, it takes a long time from start of the image-capturing until end of the judgment. When the dose of radiation for the image-capturing is within a predetermined dose range, and the captured image has no image blur and is suitable for diagnosis, the doctor judges that the reconstructed tomographic image does not need to be recaptured. On the other hand, when the dose of radiation is out of the predetermined dose range, and the captured image has image blur due to unwanted movement of the subject, the doctor judges that the image needs to be recaptured.

As described above, according to the prior art disclosed in Japanese Laid-Open Patent Publications No. 2004-130105 and No. 2004-130133, whether the image needs to be recaptured or not is judged based on the reconstructed tomographic image acquired in the tomographic image capturing process, and accordingly there is no information for making the judgment during the image-capturing process. Thus, once the tomographic image capturing process is started, the image capturing process is continuously performed until the reconstructed tomographic image is acquired even if an inappropriate reconstructed tomographic image is likely to be acquired. As a result, if it is judged that the reconstructed tomographic image is not acceptable after completion of the image-capturing process, the application of radiation to the subject for the image-capturing results in useless and needless radiation exposure.

### SUMMARY OF THE INVENTION

It is an object of the present invention to provide a tomographic image capturing apparatus and a tomographic image capturing method in which useless and needless radiation exposure with respect to a subject is prevented by discontinuing or stopping capturing a tomographic image swiftly when an inappropriate reconstructed tomographic image is likely to be obtained.

According to the present invention, the above object can be achieved by applying radiation from a radiation source to a subject at a plurality of different angles, detecting the radiation that has passed through the subject at each of the different angles and converting the radiation into image data, with a radiation detector, processing the image data into a reconstructed tomographic image with a tomographic image reconstructing unit, and determining whether image-capturing of the subject is continued or not based on the reconstructed tomographic image with an image capturing continuation determining unit.

With this arrangement, the image capturing continuation determining unit determines whether image-capturing of the subject is continued or not based on the reconstructed tomographic image generated from a plurality of image data. Thus, when an inappropriate reconstructed tomographic image is likely to be obtained, the image-capturing is discontinued or stopped swiftly even during the image-capturing process. As a result, useless and needless radiation exposure with respect to the subject can be prevented.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a tomographic image capturing apparatus according to an embodiment of the present invention;

FIGS. 2A and 2B are diagrams illustrative of the manner in which a radiation source and a radiation conversion panel shown in FIG. 1 move in forward and backward strokes; and

FIG. 3 is a flowchart of an operation sequence of the tomographic image capturing apparatus shown in FIG. 1 for carrying out a tomosynthesis image capturing process.

### DESCRIPTION OF THE PREFERRED EMBODIMENT

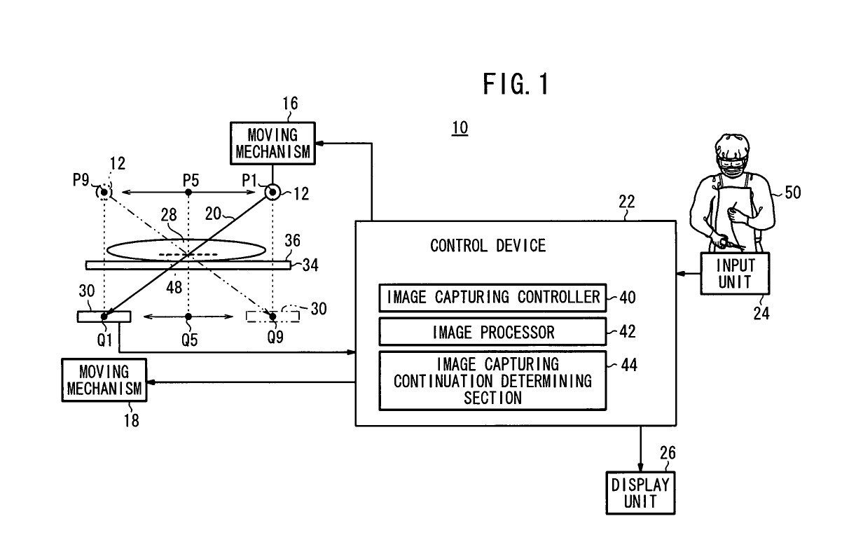

As shown in FIG. 1, a tomographic image capturing apparatus 10 according to an embodiment of the present invention comprises a radiation source 12, a radiation conversion panel (radiation detector) 30, a first moving mechanism 16, a second moving mechanism 18, a control device 22, an input unit (input unit) 24, and a display unit (output unit) 26.

The radiation source 12 emits and applies radiation 20 at a prescribed dose to a subject 28 (e.g., a patient) lying on a lying surface 36 of an image capturing base 34 in response to a command from the control device 22. The radiation conversion panel 30 detects the radiation 20 that has passed through the subject 28, converts the detected radiation 20 into radiographic image information (image data), and outputs the radiographic image information to the control device 22. The first moving mechanism 16 moves the radiation source 12 in response to a command from the control device 22. The second moving mechanism 18 moves the radiation conversion panel 30 in response to a command from the control device 22.

The control device 22 comprises a CPU (Central Processing Unit), a memory, etc., not shown, and functionally includes an image capturing controller (control unit) 40, an image processor (tomographic image reconstructing unit) 42, and an image capturing continuation determining section (image capturing continuation determining unit) 44.

The image capturing controller 40 controls the first moving mechanism 16 to move the radiation source 12 to a desired position (angle) with respect to the subject 28, and also controls the second moving mechanism 18 to move the radiation conversion panel 30 to a desired position (angle) with respect to the subject 28.

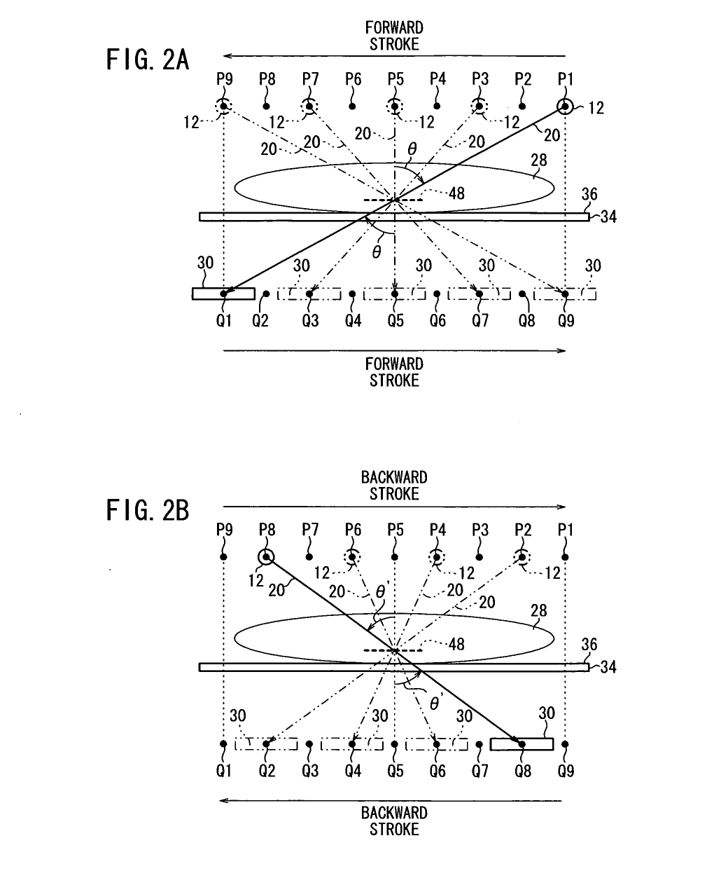

Specifically, when the tomographic image capturing apparatus 10 operates in a tomosynthesis image capturing process for acquiring a tomographic image (reconstructed tomographic image) at a sectional plane 48 at a desired sectional position (slice height) in the subject 28, the image capturing controller 40 controls the first moving mechanism 16 and the second moving mechanism 18 to move the radiation source 12 and the radiation conversion panel 30 synchronously in respective opposite horizontal directions with the subject 28 interposed therebetween while the direction in which the radiation source 12 applies the radiation 20 to the subject 28 is being held in substantial alignment with successive straight lines interconnecting positions P1 through P9 indicative of the center of the radiation source 12 and positions Q1 through Q9 indicative of the center of the radiation conversion panel 30, as shown in FIGS. 2A and 2B. While the radiation source 12 and the radiation conversion panel 30 are being moved synchronously, the image capturing controller 40 instructs the radiation source 12 to apply the radiation 20 to the subject 28 and reads the radiographic image information from the radiation conversion panel 30.

The position P1 represents a start point from which the radiation source 12 moves in a forward stroke, and also an end point to which the radiation source 12 moves in a backward stroke. The position P9 represents an end point to which the radiation source 12 moves in the forward stroke, and also a start point from which the radiation source 12 moves in the backward stroke.

The position Q1 represents a start point from which the radiation conversion panel 30 moves in a forward stroke, and also an end point to which the radiation conversion panel 30 moves in a backward stroke. The position Q9 represents an end point to which the radiation conversion panel 30 moves in the forward stroke, and also a start point from which the radiation conversion panel 30 moves in the backward stroke.

In FIG. 2A, when the radiation source 12 and the radiation conversion panel 30 move in their forward strokes, an angle θ is formed between the straight line interconnecting the points P5, Q5, which is perpendicular to the lying surface 36, and the straight lines interconnecting the positions P1 through P9 and the positions Q1 through Q9. In FIG. 2B, when the radiation source 12 and the radiation conversion panel 30 move in their backward strokes, an angle θ′ is formed between the straight line interconnecting the points P5, Q5 and the straight lines interconnecting the positions P1 through P9 and the positions Q1 through Q9.

When the radiation source 12 is moved in the forward and backward directions between the positions P1 and P9 (to the positions P1 through P9) by the first moving mechanism 16, the radiation source 12 applies the radiation 20 from the positions P1 through P9 (at the angle θ or θ′) to the subject 28. When the radiation conversion panel 30 is moved in the forward and backward directions between the positions Q1 and Q9 (to the positions P1 through P9) by the second moving mechanism 18, the radiation conversion panel 30 converts the radiation 20 having passed through the subject 28 into radiographic image information at the positions Q1 through Q9 (at the angle θ or θ′).

The tomographic image capturing apparatus 10 captures radiographic images of the subject 28 at the positions P1 through P9, Q1 through Q9 by repeatedly performing a sequential operation of movement of the radiation source 12 with the first moving mechanism 16 and movement of the radiation conversion panel 30 with the second moving mechanism 18, application of the radiation 20 from the radiation source 12 to the subject 28, and conversion of the radiation 20 having passed through the subject 28 into radiographic image in-formation with the radiation conversion panel 30.

As shown in FIGS. 2A and 2B, the first moving mechanism 16 moves the radiation source 12 in the forward direction from positions P1 through P3, P5 and P7 to P9, while skipping positions P2, P4, P6 and P8, and also moves the radiation source 12 in the backward direction from positions P8 through positions P6 and P4 to position P2, while skipping positions P9, P7, P5, P3 and P1, and the radiation source 12 applies the radiation 20 to the subject 28 at these unskipped positions. On the other hand, the second moving mechanism 18 moves the radiation conversion panels 30 in the forward direction from positions Q1 through positions Q3, Q5 and Q7 to position Q9, while skipping positions Q2, Q4, Q6 and Q8, and also moves the radiation conversion panel 30 in the backward direction from positions Q8 through positions Q6 and Q4 to position Q2, while skipping positions Q9, Q7, Q5, Q3 and Q1, and the radiation conversion panel 30 converts the radiation 20 having passed through the subject 28 into radiographic image information at these unskipped positions.

The radiation source 12 and the radiation conversion panel 30 may be moved to positions at desired intervals in their forward and backward strokes, rather than to the above alternate positions shown in FIGS. 2A and 2B.

As shown in FIG. 1, the image processor 42 processes radiographic image information (image data) according to a shift-and-add process or a filtered back projection (FBP) process, thereby generating a reconstructed tomographic image at the sectional plane 48, when the image capturing controller 40 reads the radiographic image information which the radiation conversion panel 30 has acquired each time the radiation source 12 applies the radiation 20 to the subject 28, i.e., each time a radiographic image of the subject 28 is captured at each unskipped position. The image processor 42 also performs various image correcting processes on the reconstructed tomographic image, including a gain adjusting process (sensitivity correcting process), an offset adjusting process (gradation correcting process), an edge enhancement process (frequency enhancement process), etc. The image processor 42 then displays the processed reconstructed tomographic image on the display unit 26, which comprises a display panel or the like.

The image capturing continuation determining section 44 determines whether the image-capturing in the backward stroke is continued or not, based on the reconstructed tomographic image which has been generated from the image data in the forward stroke acquired by moving the radiation source 12 and the radiation conversion panel 30 in the forward stroke in the above skipped manner. Then, the image capturing continuation determining section 44 displays the determination result on the display unit 26.

More specifically, when the dose of radiation for acquiring the reconstructed tomographic image is within a predetermined dose range (dose range that is suitable for image diagnosis by the doctor 50), or when it is judged that the reconstructed tomographic image has no image blur and is suitable for image diagnosis, the image capturing continuation determining section 44 determines that the image-capturing in the backward stroke is continuously performed (is continued). Then, the image capturing continuation determining section 44 visually displays both the reconstructed tomographic image in the forward stroke and the determination result indicating the continuation of the image-capturing in the backward stroke, on the display unit 26. Thus, the image capturing controller 40 controls the first moving mechanism 16 and the second moving mechanism 18 on the basis of the determination result, whereby the image-capturing in the backward stroke is continued.

On the other hand, when the dose of radiation for the image-capturing in the forward stroke is out of the predetermined dose range, or when the reconstructed tomographic image has image blur due to unwanted movement of the subject during the image-capturing in the forward stroke, the image capturing continuation determining section 44 judges that the reconstructed tomographic image is not acceptable. Then, the image capturing continuation determining section 44 discontinues or stops the image-capturing in the backward stroke based on the above determination result. The image capturing controller 40 visually displays both the inappropriate reconstructed tomographic image in the forward stroke and recapturing request information for requesting recapturing of the image in the forward stroke, on the display unit 26.

When the subject 28 moves a certain distance or greater between a plurality of compared image data which are processed into the reconstructed tomographic image, the image capturing continuation determining section 44 determines that the reconstructed tomographic image has image blur.

The input unit 24 serves to input commands as ordering information from a doctor (or radiographic technician) 50 for the tomosynthesis image capturing process. The input unit 24 may comprise operating buttons, a keyboard, a mouse, etc., for example. When the recapturing request information is visually displayed on the display unit 26, the doctor 50 inputs, to the input unit 24, ordering information (recapturing command information) for commanding to recapture an image. When the recapturing command information is input from the input unit 24, the image capturing controller 40 controls the first moving mechanism 16 and the second moving mechanism 18 to recapture the image in the forward stroke.

Basic details of the tomosynthesis image capturing process are disclosed in Japanese Laid-Open Patent Publications No. 2004-130105 and 2004-130133, and will not be described in detail below.

The tomographic image capturing apparatus 10 according to the present embodiment is configured as described above.

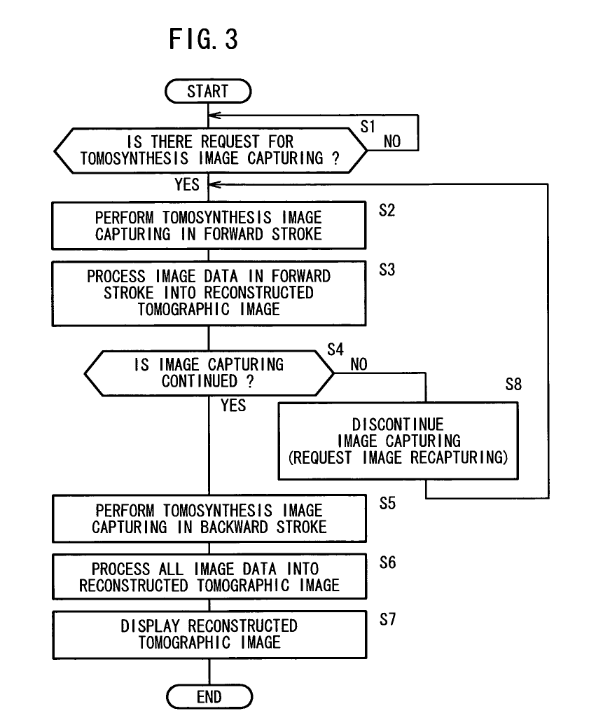

Operation (tomographic image capturing method) of the tomographic image capturing apparatus 10 will be described below with reference to a flowchart shown in FIG. 3.

In step S1 shown in FIG. 3, the control device 22 (see FIG. 1) determines whether a request for a tomosynthesis image capturing process (ordering information) has been input to the input unit 24 by the doctor 50 or not. If no request for the tomosynthesis image capturing process has been input to the input unit 24 (“NO” in step S1), then the control device 22 continues to perform step S1. If request for capturing a tomographic image has been input to the input unit 24 (“YES” in step S1), then the control device 22 performs the tomosynthesis image capturing process according to the input ordering information, in step S2.

In this case, the tomosynthesis image capturing process is carried out as follows: The image capturing controller 40 controls the first moving mechanism 16 and the second moving mechanism 18 to move the radiation source 12 and the radiation conversion panel 30 synchronously in respective opposite horizontal directions with the subject 28 interposed therebetween while skipping positions P2, P4, P6 and P8 and also skipping positions Q2, Q4, Q6 and Q8 (see FIG. 2A), and at the same time controls the radiation source 12 to apply the radiation 20 to the subject 28 at each unskipped position (positions P1, P3, P5, P7 and P9) and also controls the radiation conversion panel 30 to detect the radiation 20 that has passed through the subject 28, at each corresponding unskipped position (positions Q1, Q3, Q5, Q7 and Q9) and convert the radiation 20 into radiographic image information (image data).

When all radiographic image information necessary in the image capturing in the forward stroke is acquired, the image processor 42 of the control device 22 processes all the image data into a reconstructed tomosynthesis image in step S3, and the image capturing continuation determining section 44 determines whether the image-capturing in the backward stroke is continued or not based on the reconstructed tomosynthesis image, in step S4.

If it is judged that the reconstructed tomographic image is adequate for diagnosis (“YES” in step S4), then the image capturing continuation determining section 44 decides to continue the tomosynthesis image capturing process in the backward stroke. The image capturing continuation determining section 44 visually displays both the reconstructed tomographic image in the forward stroke and the decision to continuously perform the tomosynthesis image capturing process in the backward stroke, on the display unit 26. Based on the decision, the image capturing controller 40 controls the first moving mechanism 16 and the second moving mechanism 18 to continuously perform the tomosynthesis image capturing process in the backward stroke in step S5.

In step S5, the tomosynthesis image capturing process is carried out as follows: The image capturing controller 40 controls the first moving mechanism 16 and the second moving mechanism 18 to move the radiation source 12 and the radiation conversion panel 30 synchronously in respective opposite horizontal directions with the subject 28 interposed therebetween while skipping positions P9, P7, P5, P3 and P1 and also skipping positions Q9, Q7, Q5, Q3 and Q1 (see FIG. 2B), and at the same time controls the radiation source 12 to apply the radiation 20 to the subject 28 at each unskipped position (positions P8, P6, P4 and P2) and also controls the radiation conversion panel 30 to detect the radiation 20 that has passed through the subject 28, at each corresponding unskipped position (positions Q8, Q6, Q4 and Q2) and convert the radiation 20 into radiographic image information (image data).

When the tomosynthesis image capturing process in the backward stroke is finished and all necessary radiographic image information (image data) is acquired, the image processor 42 processes all the image data in the forward stroke and the backward stroke into a new reconstructed tomographic image in step S6. The display unit 26 displays the new reconstructed tomographic image generated by the image processor 42 as a tomographic image at the sectional plane 48 in the subject 28 (reconstructed tomographic image actually used for image diagnosis of the subject 28 by the doctor), in step S7.

On the other hand, if it is judged that the reconstructed tomographic image is not adequate for diagnosis (“NO” in step S4), the image capturing continuation determining section 44 determines discontinuation or stoppage of the image-capturing in the backward stroke (step S8), and the display unit 26 visually displays both the inadequate reconstructed tomographic image in the forward stroke and the recapturing request information for requesting the image-recapturing in the forward stroke. The doctor 50 visually confirms the contents displayed on the display unit 26, and then inputs the recapturing command information into the input unit 24. According to the recapturing command information input from the input unit 24, the process returns to step S2, and then the image capturing controller 40 controls the first moving mechanism 16 and the second moving mechanism 18 to recapture the image in the forward stroke.

With the tomographic image capturing apparatus 10 and the tomographic image capturing method according to the present embodiment, since the image capturing continuation determining section 44 determines whether the image-capturing of the subject 28 is continued or not based on the reconstructed tomographic image generated from a plurality of image data, when an inappropriate reconstructed tomographic image is likely to be obtained, the image-capturing can be discontinued or stopped swiftly even during the image-capturing process. Thus, even if the image-recapturing is required, useless and needless radiation exposure with respect to the subject 28 can be prevented.

Further, when the radiation source 12 is moved to positions P1, P3, P5, P7 and P9 (skipping positions P2, P4, P6 and P8) in the forward stroke by the first moving mechanism 16, the radiation source 12 applies the radiation 20 to the subject 28 at different angles θ (from the positions P1, P3, P5, P7 and P9), and the image capturing continuation determining section 44 determines whether the radiation source 12 is moved in the backward direction by the first moving mechanism 16 to apply the radiation 20 to the subject 28 at other different angles θ′ (from the positions P8, P6, P4 and P2) or not, based on the reconstructed tomographic image. Thus, the image capturing continuation determining section 44 can determine whether the reconstructed tomographic image is appropriate or not (i.e., whether the image-recapturing is required or not) based on only the reconstructed tomographic image generated from the image data in the forward stroke. Therefore, the determination process in the case of the present invention can be performed more quickly than in the case where it is determined whether the image-recapturing is performed or not based on the reconstructed tomographic image generated after completion of the image-capturing in the forward and backward strokes.

Further, when the image capturing continuation determining section 44 determines continuation of the image-capturing in the backward stroke (i.e., that the image-recapturing in the forward stroke is not required), the first moving mechanism 16 moves the radiation source 12 in the backward direction, the radiation source 12 applies the radiation 20 to the subject 28 at the other different angles θ′ (from the positions P8, P6, P4 and P2), and the image processor 42 processes the image data acquired by moving the radiation source 12 in the forward and backward directions, into a new reconstructed tomographic image. Thus, a reconstructed tomographic image suitable for diagnosis can be acquired reliably.

Still further, the first moving mechanism 16 can move the radiation source 12 in the forward and backward directions while skipping positions. Accordingly, the radiation source 12 applies the radiation 20 to the subject 28 at least from unskipped positions in the forward stroke, i.e., positions P1, P3, P5, P7 and P9. Consequently, the image capturing continuation determining section 44 can determine whether the reconstructed tomographic image is appropriate or not (i.e., whether the image-recapturing in the forward stroke is required or not and whether the image-capturing in the backward stroke is continued or discontinued) in a shorter period of time than if images are captured when the radiation source 12 is moved at smaller intervals in one direction.

When the image capturing continuation determining section 44 determines continuation of the image-capturing in the backward stroke, the radiation source 12 applies the radiation 20 to the subject 28 at the other different angles θ′ (from positions P8, P6, P4 and P2, which are skipped in the forward stroke) in the backward stroke such that the angles θ (positions P1, P3, P5, P7 and P9) in the forward stroke are complemented with the angles θ′ (positions P8, P6, P4 and P2) in the backward stroke. Thus, the reconstructed tomographic image according to the present invention can be acquired in a shorter period of time than in the case where images are captured by moving the radiation source 12 at smaller intervals in the forward and backward directions. Additionally, a stable reconstructed tomographic image of high quality can be acquired easily.

Further, when the first moving mechanism 16 moves the radiation source 12 in the forward and/or backward directions, the second moving mechanism 18 moves the radiation conversion panel 30 in a direction opposite to the direction in which the radiation source 12 is moved. Thus, radiographic image information (image data) can be acquired reliably, and a stable reconstructed tomographic image of high quality can be acquired reliably.

Still further, when the image capturing continuation determining section 44 determines discontinuation or stoppage of the image-capturing based on the reconstructed tomographic image, the display unit 26 displays the recapturing request information and the inappropriate reconstructed tomographic image, the doctor 50 performs an input operation on the input unit 24 based on the contents displayed on the display unit 26, and the image capturing controller 40 performs the image-recapturing in the forward stroke based on the recapturing command information input from the input unit 24. Conventionally, the doctor 50 determines whether the image-recapturing is required or not (i.e., whether the reconstructed tomographic image is appropriate or not). However, according to the present invention, the image capturing continuation determining section 44 automatically determines whether the image-recapturing is required or not. Accordingly, when the image-recapturing is performed, the doctor 50 only has to perform an input operation of the input unit 24 on the basis of the contents displayed on the display unit 26. Thus, the doctor 50 can easily grasp whether the image-recapturing is required or not, and a work burden on the doctor 50 can be reduced significantly.

Although certain preferred embodiments of the present invention have been shown and described in detail, it should be understood that various changes and modifications may be made therein without departing from the scope of the appended claims.

What is claimed is:

1. A tomographic image capturing apparatus comprising:
a radiation source for applying radiation to a subject at a plurality of different angles with respect to the subject;
a radiation detector for detecting the radiation which has passed through the subject at each of the different angles and converting the detected radiation into image data;
a tomographic image reconstructing unit for processing the image data into a reconstructed tomographic image; and
an image capturing continuation determining unit for determining whether image-capturing of the subject is continued or not based on the reconstructed tomographic image.

2. A tomographic image capturing apparatus according to claim 1, wherein when the image capturing continuation determining unit determines that the image-capturing is continued, the radiation source applies the radiation to the subject at other angles than the different angles, each of the other angles being presented between the different angles, such that the different angles are complemented with the other angles.

3. A tomographic image capturing apparatus according to claim 2, further comprising a first moving mechanism for moving the radiation source in a forward stroke and a backward stroke along the subject,
wherein a sequential operation of movement of the radiation source in the forward stroke by the first moving mechanism, application of the radiation from the moved radiation source to the subject, and conversion of the radiation into the image data by the radiation detector is repeatedly performed, thereby capturing images of the subject at the different angels,
the tomographic image reconstructing unit processes the image data acquired in the image-capturing in the forward stroke, into the reconstructed tomographic image, and
the image capturing continuation determining unit determines whether image-capturing of the subject in the backward stroke is continued or not based on the reconstructed tomographic image.

4. A tomographic image capturing apparatus according to claim 3, wherein when the image capturing continuation determining unit determines that the image-capturing in the backward stroke is continued, a sequential operation of movement of the radiation source in the backward stroke by the first moving mechanism, application of the radiation from the moved radiation source to the subject, and conversion of the radiation into the image data by the radiation detector is repeatedly performed, thereby capturing images of the subject at the other angles such that the different angles are complemented with the other angles, and
the tomographic image reconstructing unit processes the image data acquired in the image-capturing in the forward and backward strokes, into a new reconstructed tomographic image.

5. A tomographic image capturing apparatus according to claim 3, further comprising a second moving mechanism,
wherein when the first moving mechanism moves the radiation source in the forward stroke and/or in the backward stroke, the second moving mechanism moves the radiation detector in a direction opposite to a direction in which the radiation source is moved.

6. A tomographic image capturing apparatus according to claim 1, further comprising:
an output unit for outputting the reconstructed tomographic image to outside;
an input unit for inputting ordering information about the image-capturing of the subject; and
a control unit for controlling the radiation source and the radiation detector,
wherein when the image capturing continuation determining unit determines discontinuation or stoppage of the image-capturing of the subject based on the reconstructed tomographic image, the image capturing continuation determining unit outputs recapturing request information for requesting recapturing of the image of the subject, to the output unit, and
the output unit outputs the recapturing request information to outside, and
wherein when recapturing command information for commanding to recapture the image of the subject according to the recapturing request information is input from outside as the ordering information, the input unit outputs the recapturing command information to the control unit, and
the control unit controls the radiation source and the radiation detector based on the recapturing command information to apply the radiation to the subject again.

7. A tomographic image capturing method comprising the steps of:
applying radiation from a radiation source to a subject at a plurality of different angles;
detecting the radiation that has passed through the subject at each of the different angles and converting the radiation into image data, with a radiation detector;
processing the image data into a reconstructed tomographic image with a tomographic image reconstructing unit; and
determining whether image-capturing of the subject is continued or not based on the reconstructed tomographic image, with an image capturing continuation determining unit.
